(19) United States
(12) Patent Application Publication
(10) Pub. No.: US 2022/0194138 A1
(43) Pub. Date: Jun. 23, 2022

(54) TIRE

(71) Applicant: Sumitomo Rubber Industries, Ltd., Hyogo (JP)

(72) Inventors: Hiroshi YAMAOKA, Kobe-shi (JP); Yutaro INADA, Kobe-shi (JP)

(73) Assignee: Sumitomo Rubber Industries, Ltd., Hyogo (JP)

(21) Appl. No.: 17/540,493

(22) Filed: Dec. 2, 2021

(30) Foreign Application Priority Data
Dec. 17, 2020 (JP) 2020-209584

(51) Int. Cl. B60C 11/03

(52) U.S. Cl. CPC B60C 11/0332; B60C 2011/0355

(57) ABSTRACT

A tire has a tread portion provided with grooves. The ground contact area of the tread portion has ground contact lengths in the tire circumferential direction which include a crown ground contact length LC at the tire equator and a shoulder ground contact length LS at a position spaced apart from the tire equator by 80% of a half tread width Tw. The crown ground contact length LC is 0.95 to 1.05 times the shoulder ground contact length LS. Groove depths of the respective grooves are determined so as to satisfy specific mathematical equations based on a reference virtual groove G0 having a predetermined groove depth d0 and defined at the tire equator.

### FIELD OF THE INVENTION

The present disclosure relates to a tire having a tread portion.

### BACKGROUND OF THE INVENTION

Conventionally, a tire having a tread portion provided with circumferential grooves extending in the tire circumferential direction has been known.

For example, Patent Document 1 below discloses a tire improved in wear resistance by specifically defining the profile of a tread portion in which a plurality of main grooves extending in the tire circumferential direction are formed.
Patent Document 1: Japanese Patent Application Publication No. 2019-182339

### SUMMARY OF THE INVENTION

### Problems to be Solved by the Invention

In the tire of Patent Document 1, since the groove depths of the main grooves are the same and relatively large, the rigidity of the tread portion is reduced by the main grooves, therefore, the tire is required to be improved in the rigidity of the tread portion in view of the steering stability performance.

In view of the above circumstances, the present disclosure was made, and a main object of the present disclosure is to provide a tire in which steering stability performance can be improved, while maintaining excellent wear resistance performance.

### Means for Solving the Problems

According to the present disclosure, a tire comprises a tread portion provided with grooves, wherein

when the tire mounted on a normal rim and inflated to a normal internal pressure is contacted with a horizontal flat surface at a camber angle of 0 degree and loaded with a normal load, the tread portion has a ground contact area having

ground contact lengths in the tire circumferential direction associated with respective positions in the tire axial direction, and
a half tread width which is a distance from the tire equator to a tread edge which is the axially outermost end of the ground contact area,

the ground contact lengths include

a crown ground contact length LC at the tire equator, and
a shoulder ground contact length at a position spaced apart from the tire equator by an axial distance of 80% of the half tread width,
wherein

the crown ground contact length LC is 0.95 to 1.05 times the shoulder ground contact length,

wherein

given a groove depth d0 for a reference virtual groove which is defined at the axial position of the tire equator, a groove depth d of each of the grooves at an axial position satisfies the following equation (1);

d=<(L×d0×1.1)/{L+α(LC−L)} (1)

wherein
LC is the crown ground contact length at the tire equator,
L is the ground contact length of the ground contact area measured at the above-said axial position, and
α: a correction coefficient.

### Effects of the Invention

In the tire according to the present disclosure, as the crown ground contact length is 0.95 to 1.05 times the shoulder ground contact length, the tire has a large ground contact area and can improve cornering power, therefore, it is possible to improve steering stability performance. Further, as the groove depth d of each grooves is determined so as to satisfy the above equation (1), the groove depth can be prevented from becoming excessively large for the amount of wear which is different depending on the axial position. As a result, the rigidity of the tread portion is improved, and the cornering power can be improved. Therefore, the tire of the present disclosure can be improved in steering stability performance while maintaining excellent wear resistance performance.

### BRIEF DESCRIPTION OF THE DRAWINGS

FIG. 1 is a cross-sectional view of a tread portion of a tire as an embodiment of the present disclosure.

FIG. 2 is a diagram showing a ground contact area or footprint of the tire.

FIG. 3 is a cross-sectional view of a tread portion of a tire as another embodiment of the present disclosure.

FIG. 4 is a flowchart showing a method of setting a groove depth as an embodiment of the present disclosure.

### DETAILED DESCRIPTION OF THE INVENTION

The present disclosure can be applied to various tires such as a pneumatic tire for passenger cars, a pneumatic tire for heavy load vehicles, a pneumatic tire for two-wheeled vehicles, a non-pneumatic tire so called airless tire and the like. In particular, the present disclosure is suitably applied to a pneumatic tire for passenger cars.

Taking a pneumatic tire for passenger cars as an example, an embodiment of the present disclosure will now be described in detail in conjunction with accompanying drawings.

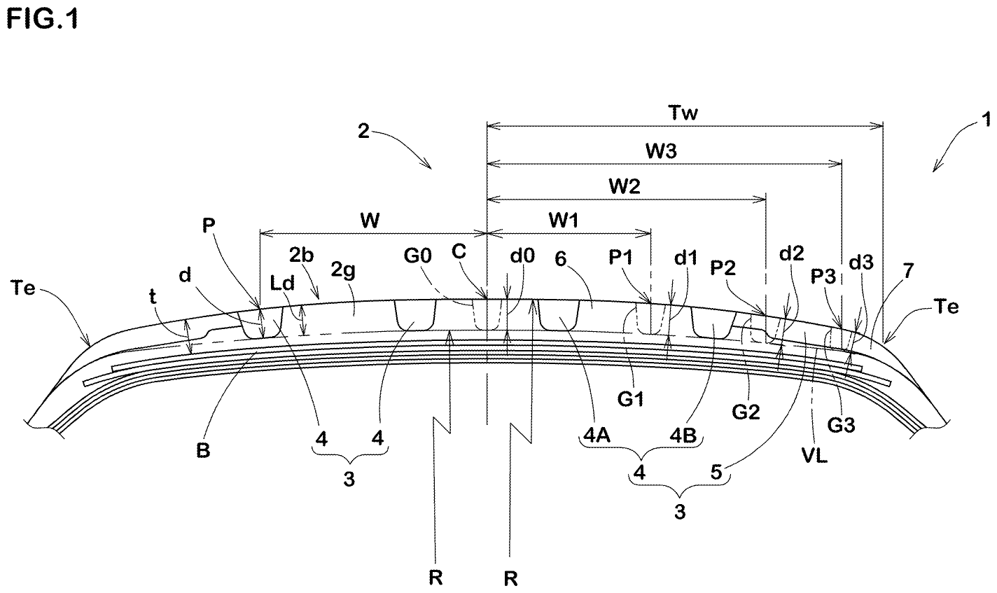

FIG. 1 is a tire meridian cross-sectional view of a tread portion 2 of a tire 1 as an embodiment under its normal state.

Here, when the tire 1 is a pneumatic tire, the “normal state” is a state of the tire 1 which is mounted on a normal rim and inflated to a normal internal pressure but load with no tire load. In the present specification, the dimensions and the like of portions of the tire 1 are values measured in the normal state unless otherwise noted.

The “normal rim” is a wheel rim specified for the tire by a standard included in a standardization system on which the tire is based, for example, the “normal wheel rim” in JATMA, “Design Rim” in TRA, and “Measuring Rim” in ETRTO. If there is no standardization system including standards on which the tire 1 is to be based, the “normal rim” is a wheel rim specified by the tire manufacturer or the like.

The “normal inner pressure” is air pressure specified for the tire by a standard included in a standardization system on which the tire is based, for example, the “maximum air pressure” in JATMA, maximum value listed in the “TIRE LOAD LIMITS AT VARIOUS COLD INFLATION PRESSURES” table in TRA, and “INFLATION PRESSURE” in ETRTO. If there is no standardization system including standards on which the tire 1 is to be based, the “normal inner pressure” is air pressure specified by the tire manufacturer or the like.

As shown in FIG. 1, the tire 1 of the present embodiment has a tread portion 2 contacting with the ground during running.

The tread portion 2 in the present embodiment is provided with grooves 3. In the present embodiment, the grooves 3 include a plurality of circumferential grooves 4, in this example, four circumferential grooves 4, each extending in the tire circumferential direction, and a plurality of lateral grooves 5 extending in the tire axial direction.

The circumferential grooves 4 in this example include a shoulder circumferential groove 4B, and a crown circumferential groove 4A disposed on the tire equator C side of the shoulder circumferential groove 4B.

the tire 1 has good drainage property when running on wet road surfaces due to such grooves 3.

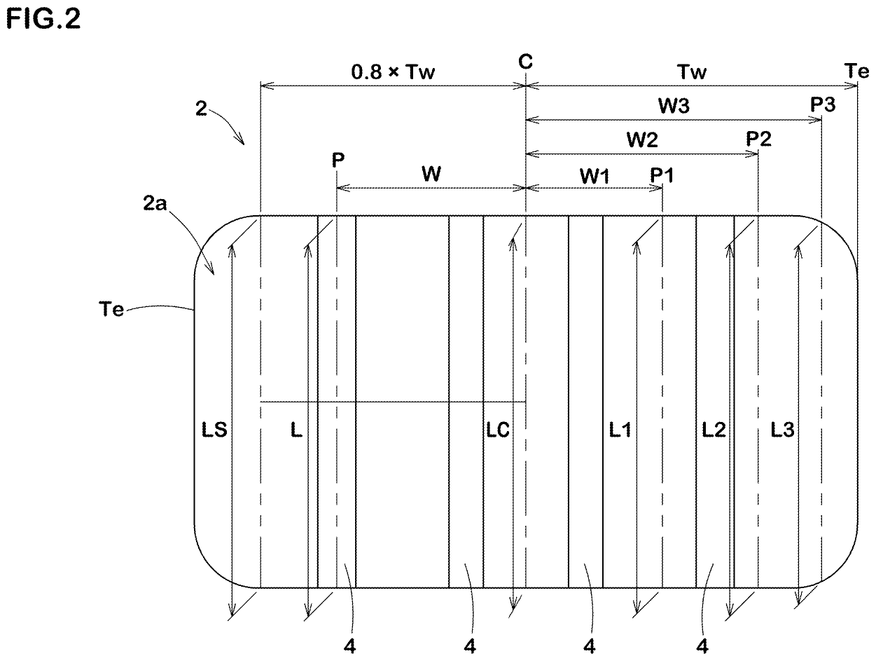

FIG. 2 is a schematic view showing a ground contact area 2a of the tread portion 2. As shown in FIG. 2, in the tread portion 2 of the present embodiment, when the tire under the normal state is contacted with a horizontal flat plane at a camber angle of 0 degree and loaded with a normal load,

the ground contact area 2a has ground contact lengths L in the tire circumferential direction associated with respective positions P in the tire axial direction.
The ground contact area 2a of the present embodiment has a half tread width Tw which is a distance from the tire equator C to a tread edge Te which is an outermost end of the ground contact area 2a in the tire axial direction.
The tire equator C is the center position in the tire axial direction between the tread edges Te on both sides.

Here, the “normal load” is a load specified for the tire by a standard included in a standardization system on which the tire is based, for example, the “maximum load capacity” in JATMA, maximum value listed in “TIRE LOAD LIMITS AT VARIOUS COLD INFLATION PRESSURES” table in TRA, and “LOAD CAPACITY” in ETRTO. If there is no standardization system including standards on which the tire 1 is to be based, the “normal load” is a load specified by the tire manufacturer or the like.

The ground contact lengths L include a crown ground contact length LC at the tire equator C, and a shoulder ground contact length LS at an axial position P1 spaced apart from the tire equator C by a distance W1 of 80% of the half tread width Tw.

In the present embodiment, the crown ground contact length LC is in a range from 0.95 to 1.05 times the shoulder ground contact length LS.
Since such tire 1 has a large ground contact area and can improve cornering power, it is possible to improve steering stability performance.

Based on a groove depth d0 predetermined for a reference virtual groove G0 defined at the axial position of the tire equator C as shown in FIGS. 1 and 2,

the depth d of each of the grooves 3 at an axial position is determined so as to satisfy the following equation (1):

d=<(L×d0×1.1)/{L+α(LC−L)} (1)

wherein
L is the ground contact length of the ground contact area 2a measured at the above-said axial position,
LC is the crown ground contact length at the tire equator C, and
α: a correction coefficient.

In such groove 3, the groove depth d can be prevented from becoming excessively large for the amount of wear which is different depending on the axial positions, and the rigidity of the tread portion 2 is improved to improve the cornering power.

Therefore, the tire 1 of the present embodiment can be improved in steering stability performance while maintaining the excellent wear resistance performance.

Preferably, the groove depth d0 of the reference virtual groove G0 is determined based on the groove depth d of the actual circumferential groove 4 disposed adjacently to the tire equator C.

For example, by determining a curve line which extends with the same radius of curvature R as the radially outer surface 2b of the tread portion at the tire equator C while contacting with the groove bottoms of the crown circumferential grooves 4A disposed on both sides of the tire equator C adjacently thereto,
the groove depth d0 of the reference virtual groove G0 is defined as the radial distance between the curve line and the radially outer surface 2b at the tire equator C.

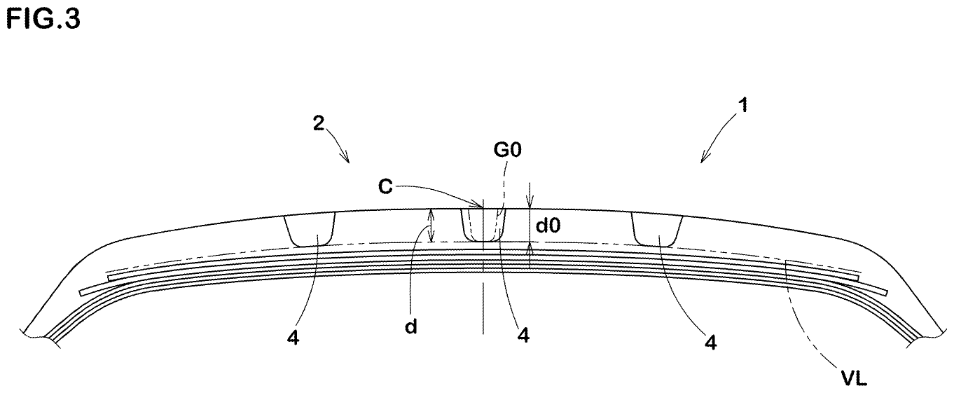

FIG. 3 shows a meridian cross section of the tread portion 2 of the tire 1 as another embodiment under the normal state.

As shown in FIG. 3, the tread portion 2 of the present embodiment is provided with three circumferential grooves 4.
One of the three circumferential grooves 4 is disposed on the tire equator C.

The groove depth d0 of the reference virtual groove G0 of the present embodiment is defined as the groove depth d of the circumferential groove 4 arranged on the tire equator C. The definition of the groove depth d0 of such reference virtual groove G0 is simple and clear.

The number of the circumferential grooves 4 may be, for example, two or five or more.

The groove depths d of the circumferential grooves 4 are preferably defined based on a virtual line VL defined in the tire meridian cross section under the normal state with no tire load as shown in FIGS. 1 and 2.

The virtual line VL of the present embodiment is defined based on the reference virtual groove G0, a first virtual groove G1, a second virtual groove G2, and a third virtual groove G3 defined in the tread portion 2 in the tire meridian cross section under the normal state with no tire load.

The reference virtual groove G0 is a virtual circumferential groove defined at the tire equator C.

The first virtual groove G1 is a virtual circumferential groove defined at a first axial position P1 spaced apart from the tire equator C in the tire axial direction.
The second virtual groove G2 is a virtual circumferential groove defined at a second axial position P2 axially outside the first axial position P1.
The third virtual groove G3 is a virtual circumferential groove defined at a third axial position P3 axially outside the second axial position P2.

Such virtual line VL can optimize the groove depth d of each circumferential groove 4 for the amount of wear, and can improve the rigidity of the tread portion 2, thereby, it is possible to improve the steering stability performance of the tire 1.

Further, the virtual line VL helps to reduce the thickness t of the tread rubber 2g of the tread portion 2 to reduce the weight of the tire 1, thereby, it is possible to improve the low-fuel consumption performance of the tire 1.
Here, the thickness t of the tread rubber 2g is the distance between the radially outer surface 2b of the tread portion 2 and a tread reinforcing layer (belt) B disposed in the tread portion 2.

The ground contact lengths L include a first ground contact length L1 at the first axial position P1, a second ground contact length L2 at the second axial position P2, and a third ground contact length L3 at the third axial position P3.

Such first ground contact length L1, second ground contact length L2, and third ground contact length L3 are useful for accurately defining the virtual line VL.

The groove depth d1 of the first virtual groove G1 is preferably determined by the following equation (2):

d1=(L1×d0)/{L1+α(LC−L1)} (2)

wherein
d0 is the groove depth of the reference virtual groove,
LC is the crown ground contact length,
L1 is the first ground contact length, and
α is the correction coefficient.

The groove depth d2 of the second virtual groove G2 is preferably determined by the following equation (3):

d2=(L2×d0)/{L2+α(LC−L2)} (3)

wherein
d0 is the groove depth of the reference virtual groove,
LC is the crown ground contact length,
L2 is the second ground contact length, and
α is the correction coefficient.

The groove depth d3 of the third virtual groove G3 is preferably determined by the following equation (4):

d3=(L3×d0)/{L3+α(LC−L3)} (4)

wherein
d0 is the groove depth of the reference virtual groove,
LC is the crown ground contact length,
L3 is the third ground contact length, and
α is the correction coefficient.

The correction coefficient α is preferably a positive number of 2.0 or less.

As the correction coefficient α is 2.0 or less, it is possible to suppress excessive correction caused by the differences of the first ground contact length L1, the second ground contact length L2, and the third ground contact length L3 from the crown ground contact length LC.
As the correction coefficient α is a positive number, it is possible to reliably correct based on the differences of the first ground contact length L1, the second ground contact length L2, and the third ground contact length L3 from the crown ground contact length LC.
More preferably, the correction coefficient α is 0.8 to 1.2.

The virtual line VL of the present embodiment is defined so as to contact with the groove bottom of the reference virtual groove G0, the groove bottom of the first virtual groove G1, the groove bottom of the second virtual groove G2, and the groove bottom of the third virtual groove G3.

The groove depth d of each circumferential groove 4 of the present embodiment is in a range from 90% to 110% of the distance Ld from the radially outer surface 2b of the tread portion 2 to the virtual line VL measured at the axial position P at which the circumferential groove 4 is formed.

Such circumferential groove 4 is prevented from having an excessively large groove depth d for the amount of wear which is different depending on the positions P in the tire axial direction, and thereby the rigidity of the tread portion 2 is improved. Therefore, the tire 1 of the present embodiment can be improved in steering stability performance while maintaining the excellent wear resistance performance.

The first axial position P1 is preferably spaced apart from the tire equator C at an axial distance W1 of from 40% to 55% of the half tread width Tw.

The first axial position P1 in this example is located in a middle land portion 6 defined between the crown circumferential groove 4A and the shoulder circumferential groove 4B.

The second axial position P2 is preferably spaced apart from the tire equator C by an axial distance W2 of from 75% to 80% of the half tread width Tw.

The second axial position P2 in this example is located in a shoulder land portion 7 defined as extending axially outwardly from the shoulder circumferential groove 4B.
When the axial distance W2 is 80% of the half tread width Tw, the second ground contact length L2 is equal to the shoulder ground contact length LS.

The third axial position P3 is preferably spaced apart from the tire equator C by a distance W3 of from 90% to 85% of the half tread width Tw.

The third axial position P3 in this example is located in the shoulder land portion 7 axially outside the shoulder circumferential groove 4B.

By the reference virtual groove G0, the first virtual groove G1, the second virtual groove G2, and the third virtual groove G3, the virtual line VL can be accurately defined over the entire range from the tire equator C to the tread edge Te.

The circumferential grooves 4 in the present embodiment include an axially inner first circumferential groove, and an axially outer second circumferential groove.

The first circumferential groove is, for example, the crown circumferential groove 4A. The second circumferential groove is, for example, the shoulder circumferential groove 4B.
In the present embodiment, the groove depth of the second circumferential groove is larger than the groove depth of the first circumferential groove.
In such circumferential grooves 4, when the tread portion 2 is worn, the remaining groove depths become almost equal. As a result, it is possible to achieve the durability performance as well as the low-fuel consumption performance owing to weight reduction.

In the present embodiment, the groove depth d of the lateral groove 5 at an axial position P is equal to or less than the distance Ld from the radially outer surface 2b to the virtual line VL at the axial position P. The virtual line VL can optimize the maximum value for the groove depth d of the lateral groove 5.

The groove bottom of the lateral groove 5 may extend along the virtual line VL.

Next, for the tire 1 whose tread portion is provided with a plurality of circumferential grooves 4 extending in the tire circumferential direction, a method of setting the groove depth d of the circumferential groove 4 is described with reference to FIGS. 1 to 3.

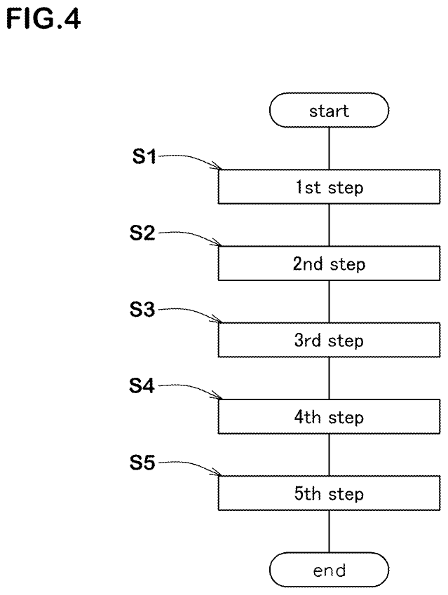

FIG. 4 is a flowchart of the groove depth setting method according to the present embodiment.

In this method, as shown in FIG. 4, a first step S1 of determining the ground contact area 2a of the tread portion 2 when the tire 1 under the normal state is contacted with a horizontal flat plane at a camber angle of 0 degree and loaded with a normal load, is performed.
In the first step S1, the ground contact area 2a may be determined through a simulation using a computer, or an experiment.
In the first step S1, the shape of the ground contact area 2a is obtained accurately.

In the groove depth setting method of the present embodiment, after the first step S1, there is performed a second step S2 of obtaining the ground contact length L in the tire circumferential direction of the ground contact area 2a associated with each position P in the tire axial direction of the ground contact area 2a.

In the second step S2 of the present embodiment, at least the crown ground contact length LC and the shoulder ground contact length LS are obtained.
In the second step S2, it is desirable that the first ground contact length L1, the second ground contact length L2, and the third ground contact length L3 are obtained.
In the second step S2, it is not necessary to obtain the ground contact length L associated with all positions P in the tire axial direction to shorten the calculation time.

In the groove depth setting method of the present embodiment, after the second step S2, performed is a third step S3 of defining the reference virtual groove G0, the first virtual groove G1, the second virtual groove G2, and the third virtual groove G3.

In this example, the third step S3 defines the groove depth d0 of the reference virtual groove G0, the groove depth d1 of the first virtual groove G1, the groove depth d2 of the second virtual groove G2, and the groove depth d3 of the third virtual groove G3.

In the groove depth setting method of the present embodiment, after the third step S3, there is performed a fourth step S4 of defining the virtual line VL by a tangential line contacting with the groove bottom of the reference virtual groove G0, the groove bottom of the first virtual groove G1, the groove bottom of the second virtual groove G2, and the groove bottom of the third virtual groove G3.

In the groove depth setting method of the present embodiment, after the fourth step S4, there is performed a fifth step S5 of determining the groove depth d of each circumferential groove 4 so that the groove bottom is located on the virtual line VL.

In such groove depth setting method, the groove depth d of the circumferential groove 4 can be optimized for the amount of wear which is different depending on the axial positions, and thereby the rigidity of the tread portion 2 can be improved.
Therefore, the groove depth setting method can improve the steering stability performance while maintaining the excellent wear resistance performance of the tire 1.

In the groove depth setting method, for example, it may be possible to define the virtual line VL by using virtual circles defined so as to have respective centers on the radially outer surface 2b of the tread portion 2, instead of the virtual grooves.

While detailed description has been made of preferable embodiments of the present disclosure, the present disclosure can be embodied in various forms without being limited to the illustrated embodiments.

### Comparison Tests

Based on the structure shown in FIG. 1, pneumatic tires having circumferential grooves were experimentally manufactured as test tires including working examples and comparative example.

In the working examples, the groove depths of the circumferential grooves were determined based on the equations (2) to 4).
In the comparative example, the circumferential grooves had the same groove depth.
The specifications are shown in Table 1.
The tires were tested for the wear resistance performance, steering stability performance, noise performance and low-fuel consumption performance.
The common specifications of the test tires and test methods are as follows.

### <Common Specifications>

Tire size: 255/65R18
Rim size: 18×7.5 J

### <Wear Resistance Performance Test>

Each test tire was attached to all wheels of a test vehicle, and after the vehicle had run for 20000 km on a dry paved road surface, tread wear was measured at different axial positions to obtain the amount of wear at the axial position where the wear was most progressed.
The obtained results are indicated in Table 1 by an index based on Comparative Example being 100, wherein the larger the value, the less the wear progresses, namely, the better the wear resistance performance.

### <Steering Stability Performance Test>

Using a flat belt tester, the cornering power of each test tire was measured when the tire mounted on a normal rim, inflated to a normal internal pressure and load with a normal tire load was running on the belt with a slip angle of 1 degree at a speed of 30 km/h.
The results are indicated in Table 1 by an index based on Comparative Example being 100,
wherein the larger the value, the larger the cornering power, namely, the better the steering stability performance.

### <Noise Performance Test>

Each test tire was attached to all wheels of a test vehicle, and the pass-by noise was measured outside the test vehicle when running on a noise measuring road surface of a tire test course.
The results are indicated in Table 1 by an index based on Comparative Example being 100,
wherein the larger the value, the smaller the noise, namely, the better the noise performance.

### <Low-Fuel Consumption Performance Test>

The weight of each test tire was measured.
The results are indicated in Table 1 by an index based on Comparative Example being 100, wherein the larger the value, the lighter the weight, namely, the better the low-fuel consumption performance.

TABLE 1

| | comparative | working | working | working |
|---|---|---|---|---|
| tire | example | example 1 | example 2 | example 3 |
| Correction | — | 0.1 | 1.0 | 2.0 |
| coefficient α | | | | |
| Wear resistance | 100 | 100 | 100 | 100 |
| performance | | | | |
| Steering stability | 100 | 103 | 105 | 103 |
| performance | | | | |
| Noise performance | 100 | 103 | 105 | 103 |
| Low-fuel consumption | 100 | 103 | 105 | 103 |
| performance | | | | |

Form the test results, it was confirmed that, as compared with the comparative example, the tires according to the present disclosure were improved in steering stability performance while maintaining comparable wear resistance performance, and exhibited excellent noise performance and low-fuel consumption performance.

### STATEMENT OF THE PRESENT DISCLOSURE

The present disclosure is as follows:
Disclosure 1. A tire comprising a tread portion provided with grooves, wherein

when the tire mounted on a normal rim and inflated to a normal internal pressure is contacted with a horizontal flat surface at a camber angle of 0 degree and loaded with a normal load, the tread portion has a ground contact area having

ground contact lengths in the tire circumferential direction associated with respective positions in the tire axial direction, and
a half tread width which is a distance from the tire equator to a tread edge which is the axially outermost end of the ground contact area,

the ground contact lengths include

a crown ground contact length LC at the tire equator, and
a shoulder ground contact length at a position spaced apart from the tire equator by an axial distance of 80% of the half tread width,
wherein

the crown ground contact length LC is 0.95 to 1.05 times the shoulder ground contact length,

wherein

given a groove depth d0 for a reference virtual groove defined at the axial position of the tire equator, a groove depth d of each of the grooves at an axial position satisfies the following equation (1);

d=<(L×d0×1.1)/{L+α(LC−L)} (1)

wherein
LC is the crown ground contact length at the tire equator,
L is the ground contact length of the ground contact area measured at said axial position, and
α: a correction coefficient.
Disclosure 2. The tire according to Disclosure 1, wherein the grooves include circumferential grooves extending in the tire circumferential direction,
wherein

in a meridian cross section of the tire mounted on the normal rim, inflated to the normal internal pressure and loaded with no tire load,

when

the reference virtual groove is defined,

a first virtual groove is defined at a first axial position spaced apart from the tire equator in the tire axial direction,

a second virtual groove is defined at a second axial position axially outside the first axial position,

a third virtual groove is defined at a third axial position axially outside the second axial position, and

a virtual line is defined so as to contact with a groove bottom of the reference virtual groove, a groove bottom of the first virtual groove, a groove bottom of the second virtual groove, and a groove bottom of the third virtual groove,

then

the groove depth of each circumferential groove is in a range from 90% to 110% of the distance from the radially outer surface of the tread portion to the virtual line at the axial position of said each circumferential groove,

wherein

the groove depth d1 of the first virtual groove,

the groove depth d2 of the second virtual groove, and
the groove depth d3 of the third virtual groove are determined
based on the following equations (2) to (4):

d1=(L1×d0)/{L1+α(LC−L1)} (2)

d2=(L2×d0)/{L2+α(LC−L2)} (3)

d3=(L3×d0)/{L3+α(LC−L3)} (4)

wherein
d0 is the groove depth of the reference virtual groove,
LC is the crown ground contact length,
L1 is a first ground contact length at the first axial position,
L2 is a second ground contact length at the second axial position,
L3 is a third ground contact length at the third axial position, and
α is a correction coefficient.
Disclosure 3. The tire according to Disclosure 2, wherein the first axial position is spaced apart from the tire equator by an axial distance of from 40% to 55% of the half tread width,

the second axial position is spaced apart from the tire equator by an axial distance of from 75% to 80% of the half tread width, and

the third axial position is spaced apart from the tire equator by an axial distance of from 90% to 85% of the half tread width.

Disclosure 4. The tire according to Disclosure 2 or 3, wherein
the correction coefficient α is a positive number of 2.0 or less.
Disclosure 5. The tire according to Disclosure 4, wherein
the correction coefficient α is in a range from 0.8 to 1.2.
Disclosure 6. The tire according to any one of Disclosures 2 to 5,
wherein the circumferential grooves include an axially inner first circumferential groove and an axially outer second circumferential groove, and

the groove depth of the second circumferential groove is larger than the groove depth of the first circumferential groove.

Disclosure 7. The tire according to any one of Disclosures 1 to 6, wherein the grooves include lateral grooves extending in the tire axial direction.

### DESCRIPTION OF THE REFERENCE SIGNS

1 tire
2 tread portion
2a ground contact area
3 groove
4 circumferential groove
5 lateral groove

1. A tire comprising a tread portion provided with grooves, wherein
when the tire mounted on a normal rim and inflated to a normal internal pressure is contacted with a horizontal flat surface at a camber angle of 0 degree and loaded with a normal load, the tread portion has a ground contact area having
ground contact lengths in the tire circumferential direction associated with respective positions in the tire axial direction, and
a half tread width which is a distance from the tire equator to a tread edge which is the axially outermost end of the ground contact area,
the ground contact lengths include
a crown ground contact length LC at the tire equator, and
a shoulder ground contact length at a position spaced apart from the tire equator by an axial distance of 80% of the half tread width,
wherein
the crown ground contact length LC is 0.95 to 1.05 times the shoulder ground contact length,
wherein
given a groove depth d0 for a reference virtual groove defined at the axial position of the tire equator,
a groove depth d of each of the grooves at an axial position satisfies the following equation (1);
d=<(L×d0×1.1)/{L+α(LC−L)} (1)
wherein
LC is the crown ground contact length at the tire equator,
L is the ground contact length of the ground contact area measured at said axial position, and
α: a correction coefficient.

2. The tire according to claim 1, wherein
the grooves include circumferential grooves extending in the tire circumferential direction, wherein
in a meridian cross section of the tire mounted on the normal rim, inflated to the normal internal pressure and loaded with no tire load,
when
the reference virtual groove is defined,
a first virtual groove is defined at a first axial position spaced apart from the tire equator in the tire axial direction,
a second virtual groove is defined at a second axial position axially outside the first axial position,
a third virtual groove is defined at a third axial position axially outside the second axial position, and
a virtual line is defined so as to contact with a groove bottom of the reference virtual groove, a groove bottom of the first virtual groove, a groove bottom of the second virtual groove, and a groove bottom of the third virtual groove,
then
the groove depth of each circumferential groove is in a range from 90% to 110% of the distance from the radially outer surface of the tread portion to the virtual line at the axial position of said each circumferential groove,
wherein
the groove depth d1 of the first virtual groove,
the groove depth d2 of the second virtual groove, and
the groove depth d3 of the third virtual groove are determined
based on the following equations (2) to (4):
d1=(L1×d0)/{L1+α(LC−L1)} (2)
d2=(L2×d0)/{L2+α(LC−L2)} (3)
d3=(L3×d0)/{L3+α(LC−L3)} (4)
wherein
d0 is the groove depth of the reference virtual groove,
LC is the crown ground contact length,
L1 is a first ground contact length at the first axial position,
L2 is a second ground contact length at the second axial position,
L3 is a third ground contact length at the third axial position, and
α is a correction coefficient.

3. The tire according to claim 2, wherein
the first axial position is spaced apart from the tire equator by an axial distance of from 40% to 55% of the half tread width,
the second axial position is spaced apart from the tire equator by an axial distance of from 75% to 80% of the half tread width, and
the third axial position is spaced apart from the tire equator by an axial distance of from 90% to 85% of the half tread width.

4. The tire according to claim 2, wherein
the correction coefficient α is a positive number of 2.0 or less.

5. The tire according to claim 3, wherein
the correction coefficient α is a positive number of 2.0 or less.

6. The tire according to claim 4, wherein
the correction coefficient α is in a range from 0.8 to 1.2.

7. The tire according to claim 5, wherein
the correction coefficient α is in a range from 0.8 to 1.2.

8. The tire according to claim 2, wherein
the circumferential grooves include an axially inner first circumferential groove and an axially outer second circumferential groove, and
the groove depth of the second circumferential groove is larger than the groove depth of the first circumferential groove.

9. The tire according to claim 3, wherein
the circumferential grooves include an axially inner first circumferential groove and an axially outer second circumferential groove, and
the groove depth of the second circumferential groove is larger than the groove depth of the first circumferential groove.

10. The tire according to claim 4, wherein
the circumferential grooves include an axially inner first circumferential groove and an axially outer second circumferential groove, and
the groove depth of the second circumferential groove is larger than the groove depth of the first circumferential groove.

11. The tire according to claim 5, wherein
the circumferential grooves include an axially inner first circumferential groove and an axially outer second circumferential groove, and
the groove depth of the second circumferential groove is larger than the groove depth of the first circumferential groove.

12. The tire according to claim 6, wherein
the circumferential grooves include an axially inner first circumferential groove and an axially outer second circumferential groove, and
the groove depth of the second circumferential groove is larger than the groove depth of the first circumferential groove.

13. The tire according to claim 7, wherein
the circumferential grooves include an axially inner first circumferential groove and an axially outer second circumferential groove, and
the groove depth of the second circumferential groove is larger than the groove depth of the first circumferential groove.

14. The tire according to claim 1, wherein
the grooves include lateral grooves extending in the tire axial direction.

15. The tire according to claim 2, wherein
the grooves include lateral grooves extending in the tire axial direction.

16. The tire according to claim 3, wherein
the grooves include lateral grooves extending in the tire axial direction.

17. The tire according to claim 4, wherein
the grooves include lateral grooves extending in the tire axial direction.

18. The tire according to claim 5, wherein
the grooves include lateral grooves extending in the tire axial direction.

19. The tire according to claim 6, wherein
the grooves include lateral grooves extending in the tire axial direction.

20. The tire according to claim 8, wherein
the grooves include lateral grooves extending in the tire axial direction.
